(19) United States
(12) Patent Application Publication
(10) Pub. No.: US 2011/0264294 A1
(43) Pub. Date: Oct. 27, 2011

(54) SET-TOP BOX AND ENERGY MANAGEMENT METHOD

(75) Inventor: LIAN-FANG CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 12/844,808

(22) Filed: Jul. 27, 2010

(30) Foreign Application Priority Data
Apr. 27, 2010 (CN) 201010157829.4

(51) Int. Cl. G06F 1/32; G06F 1/28

(52) U.S. Cl. 700/295

(57) ABSTRACT

A set-top box sets a plurality of energy consumption thresholds corresponding to a plurality of electrical appliances. The set-top box transmits a plurality of energy request commands to the plurality of electrical appliances via a power line communication (PLC) transport protocol to request for energy consumption of the plurality of electrical appliances, and receives a plurality of energy response messages from the plurality of electrical appliances via the PLC transport protocol. The plurality of energy response messages includes the energy consumption of the plurality of electrical appliances. The set-top box determines whether each energy consumption of each electrical appliance exceeds the corresponding energy consumption threshold, and generates an energy alarm to notify a user that at least one electrical appliance will be powered off when the energy consumption of the at least one electrical appliance exceeds the corresponding energy consumption threshold.

### BACKGROUND

1. Technical Field

Embodiments of the present disclosure relate to network communications, and more particularly to a set-top box and an energy management method.

2. Description of Related Art

With the quick development of electric technologies, electric appliances are widely used all over the world. Accordingly, energy consumption of the electric appliances is greatly increased, as well as carbon dioxide generated by the electrical appliances is rapidly increased. One the one hand, the consumed energy needs more resources to produce, and the generated carbon dioxide is destroying the environment of the earth. In order to obtain sustainable development of the earth in the future and meet the requirement for the electric appliances in our daily life, one solution is to develop power saving technology.

Therefore, it is a big challenge to provide an energy management method that can reduce energy consumption and costs.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment and functional modules of one embodiment of a set-top box in accordance with the present disclosure;

FIG. 2 is a schematic diagram of one embodiment of a transport control protocol (TCP) packet used by a set-top box in according with the present disclosure; and

FIG. 3 is a flowchart of one embodiment of an energy management method in accordance with the present disclosure.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

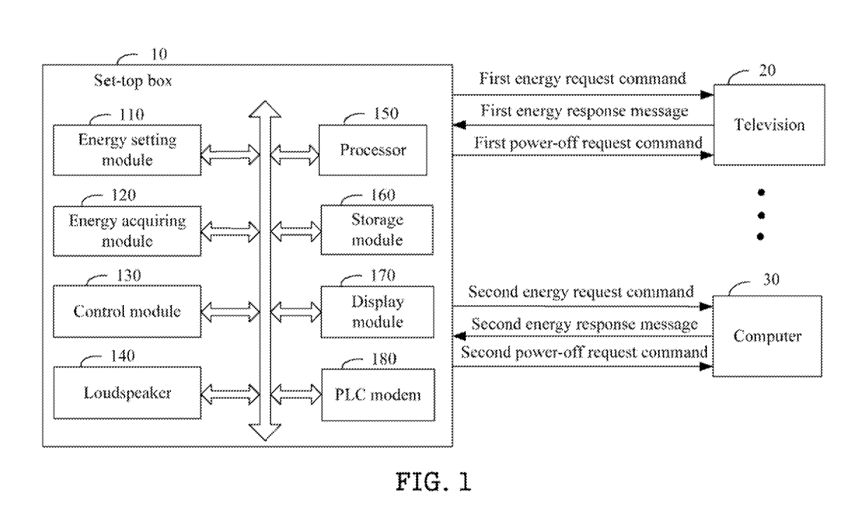

FIG. 1 is a schematic diagram of an application environment and functional modules of one embodiment of a set-top box 10 in accordance with the present disclosure.

In one embodiment, the set-top box 10 establishes a power line communication (PLC) with a plurality of electric appliances including a television 20, a computer 30 and so on. In one example, plugs of the set-top box 10 and the plurality of electrical appliances are inserted in sockets of a power line, and then the set-top box 10 establishes the PLC with the plurality of electrical appliances without additional power lines.

In one embodiment, the set-top box 10 needs an additional PLC modem 180 that can help the set-top box 10 to support the PLC if the set-top box 10 does not support the PLC. The set-top box 10 does not need the additional PLC modem 180 if the set-top box 180 supports the PLC.

In one embodiment, the set-top box 10 manages energy consumption of the plurality of electrical appliances, and includes an energy setting module 110, an energy acquiring module 120, a control module 130, at least one processor 150, and a storage system 160. The modules 110, 120, 130 may comprise one or more computerized instructions which may be in the storage system 160 and executed by the at least one processor 150.

The energy setting module 110 is operable to set a plurality of energy consumption thresholds corresponding to the plurality of electrical appliances. In one embodiment, each energy consumption threshold is maximum energy consumption consumed by each electrical appliance in a predetermined time period. The predetermined time period may be one day, one week, one month, or one year. For example, the energy consumption threshold corresponding to the computer 30 is 2 kilowatt-hour (kwh) per week, which indicates that the computer 30 can consume energy consumption no more than 2 kwh in one week.

The energy acquiring module 120 is operable to transmit a plurality of energy request commands to the plurality of electrical appliances via a PLC transport protocol to request for energy consumption of the plurality of electrical appliances, and receive a plurality of energy response messages from the plurality of electrical appliances via the PLC transport protocol. In one embodiment, the plurality of energy response messages include the energy consumption of the plurality of electrical appliances. The PLC transport protocol is a transport control protocol (TCP) applied in the PLC. The energy request commands and the energy response messages are TCP packets. It should be understood that the TCP packets are packets defined by the TCP.

In one example, referring to FIG. 1, the energy acquiring module 120 transmits a first energy request command to the television 20 via the PLC transport protocol to request for energy consumption of the television 20, and receives a first energy response message from the television 20 via the PLC transport protocol. The first energy response message includes the energy consumption of the television 20.

In another example, referring to FIG. 1, the energy acquiring module 120 transmits a second energy request command to the computer 30 via the PLC transport protocol to request for energy consumption of the computer 30, and receives a second energy response message from the computer 30 via the PLC transport protocol. The second energy response message includes the energy consumption of the computer 30.

The control module 130 is operable to determine whether each energy consumption of each electrical appliance exceeds the corresponding energy consumption threshold, and generate an energy alarm to notify a user that at least one of the plurality of the electrical appliances will be powered off when the energy consumption of the at least one electrical appliance exceeds the corresponding energy consumption threshold.

For example, the control module 130 determines that the energy consumption of the television 20 exceeds the corresponding energy consumption threshold, and generates an energy alarm to notify a user that the television 20 will be powered off.

In one embodiment, the set-top box 10 further includes a loudspeaker 140. The control module 130 may drive the loudspeaker 140 to generate the energy alarm.

In another embodiment, the control module 130 may drive the television 20 to generate the energy alarm when the television 20 is turned on.

The control module 130 is further operable to determine whether the energy alarm is canceled by the user. If the energy alarm is not canceled, the control module 130 transmits a power-off request command to the at least one electrical appliance via the PLC transport protocol to power off the at least one electrical appliance whose energy consumption exceeds the corresponding energy consumption threshold. If the energy alarm is canceled, the control module 130 notifies the user to reset the energy consumption threshold corresponding to the at least one electrical appliance.

In one example, referring to FIG. 1, when the energy consumption of the television 20 exceeds the corresponding energy consumption threshold and the corresponding energy alarm is not canceled, the control module 130 transmits a first power-off request command to the television 20 via the PLC transport protocol to power off the television 20.

In another example, referring to FIG. 1, when the energy consumption of the computer 30 exceeds the corresponding energy consumption threshold and the corresponding energy alarm is not canceled, the control module 130 transmits a second power-off request command to the computer 30 via the PLC transport protocol to power off the computer 30.

The storage system 160 is further operable to store the energy consumption thresholds corresponding to the plurality of electrical appliances and a plurality of device identifiers corresponding to the plurality of the electrical appliances. In one embodiment, each of the plurality of device identifiers is used to identify each of the plurality of electrical appliances. For example, the device identifier corresponding to the television 20 may be 0001, and the device identifier corresponding to the computer 30 may be 0010.

The set-top box 10 may further include a display module 170 operable to display the energy consumption of the plurality of electrical appliances, such as “television: 2 kwh” and “computer: 1 kwh”. In one embodiment, the display module 170 may be a liquid crystal display.

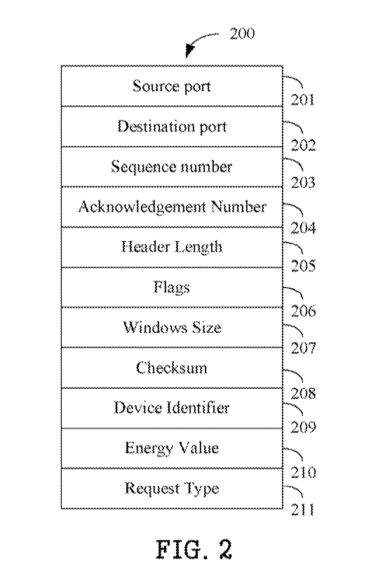

FIG. 2 is a schematic diagram of one embodiment of a TCP packet used by the set-top box 10 in according with the present disclosure. In one embodiment, the TCP packet 200 may be an energy request command, an energy response message, or a power-off request command transmitted between the set-top box 10 and the plurality of electrical appliances.

The TCP packet 200 includes a source port field 201, a destination port field 202, a sequence number field 203, an acknowledgement number field 204, a header length field 205, a flags field 206, a windows size field 207, a checksum field 208, a device identifier field 209, an energy value field 210, and a request type field 211. The source port field 201, the destination port field 202, the sequence number field 203, the acknowledgement number field 204, the header length field 205, the flags field 206, the windows size field 207, and the checksum field 208 are universal fields defined by the TCP protocol. The universal fields are set according to the TCP protocol. The device identifier field 209, the energy value field 210, and the request type field 211 are unique fields defined based on option fields of the TCP protocol by the present disclosure.

The present disclosure are executed by the source port field 201, the destination port field 202, the device identifier field 209, the energy value field 210, and the request type field 211, so detailed descriptions will be described hereinafter.

In a first embodiment, when the TCP packet 200 is an energy request command, the source port field 201 is set to a port of the set-top box 10, the destination port field 202 is set to a port of one of the plurality of electrical appliances, the device identifier field 209 is set to one device identifier corresponding to the one electrical appliance, and the request type field 211 is set to energy query datagram predefined between the set-top box 10 and the one electrical appliance. When the TCP packet 200 is an energy request command, the energy value field 210 is meaningless, and can be set to 0000.

For example, the TCP packet 200 is an energy request command transmitted from the set-top box 10 to the computer 30, the port of the set-top box 10 is 2026, the port of the computer 30 is 16538, the device identifier corresponding the computer 30 is 0110, and the energy query datagram predefined between the set-top box 10 and the computer 30 is 0001. In such a case, the source port field 201 is set to 2026, the destination port field 202 is set to 16538, the device identifier field 209 is set to 0110, the energy value field 210 is set to 0000, and the request type field 211 is set to 0001.

In a second embodiment, when the TCP packet 200 is an energy response message, the source port field 201 is set to a port of one of the plurality of electrical appliances, the destination port field 202 is set to a port of the set-top box 10, the device identifier field 209 is set to one device identifier corresponding to the one electrical appliance, and the energy value field 210 is set to energy consumption of the one electrical appliance. When the TCP packet 200 is an energy response message, the request type field 211 is meaningless, and can be set to 0000.

For example, the TCP packet 200 is an energy response message transmitted from the computer 30 to the set-top box 10, the port of the set-top box 10 is 2026, the port of the computer 30 is 16538, the device identifier corresponding to the computer 30 is 0110, and the energy consumption of the computer 30 is 00c8. In such a case, the source port field 201 is set to 16538, the destination port field 202 is set to 2026, the device identifier field 209 is set to 0110, the energy value field 210 is set to 00c8, and the request type field 211 is set to 0000.

In a third embodiment, when the TCP packet 200 is a power-off request command, the source port field 201 is set to the port of the set-top box 10, the destination port field 202 is set to a port of one of the plurality of electrical appliances, the device identifier field 209 is set to one device identifier corresponding to the one electrical appliance, and the request type field 211 is set to power-off request datagram predefined between the set-top box 10 and the one electrical appliance. When the TCP packet 200 is a power-off request command, the energy value field 210 is meaningless, and can be set to 0000.

For embodiment, the TCP packet 200 is a power-off request command transmitted from the set-top box 10 to the computer 30, the port of the set-top box 10 is 2026, the port of the computer 30 is 16538, the device identifier corresponding to the computer 30 is 0110, and the power-off request datagram predefined between the set-top box 10 and the computer 30 is 0002. In such a case, the source port field 201 is set to 2026, the destination port field 202 is set to 16538, the device identifier field 209 is set to 0110, the energy value field 210 is set to 0000, and the request type field 211 is set to 0002.

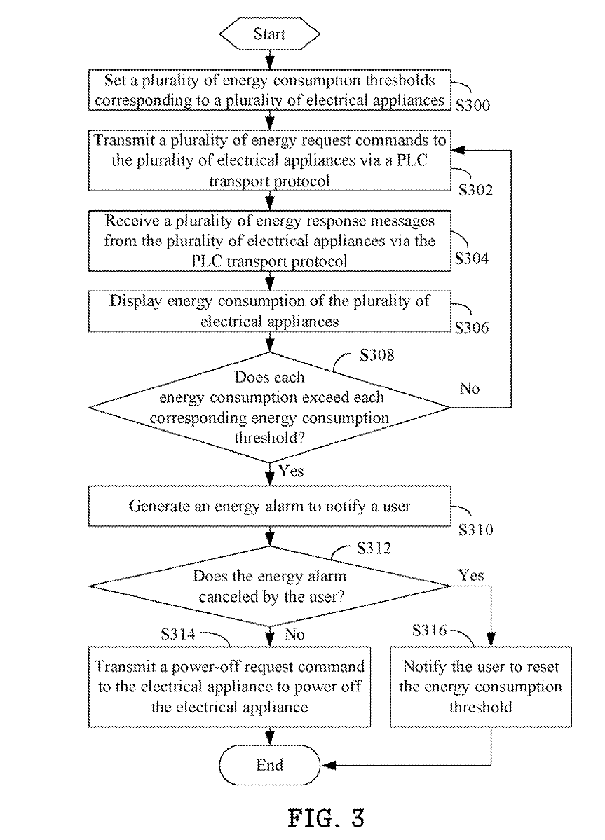

FIG. 3 is a flowchart of one embodiment of an energy management method in accordance with the present disclosure. Depending on the embodiment, additional blocks may be added, others deleted, and the ordering of blocks may be changed while remaining well within the scope of the disclosure.

In block S300, the energy setting module 110 sets a plurality of energy consumption thresholds corresponding to the plurality of electrical appliances. In one embodiment, each energy consumption threshold is maximum energy consumption consumed by each corresponding electrical appliance in a predetermined time period. The predetermined time period may be one day, one week, one month, or one year. For example, the energy consumption threshold is 2 kwh per week.

In block S302, the energy acquiring module 120 transmits a plurality of energy request commands to the plurality of electrical appliances via a PLC transport protocol to request for energy consumption of the plurality of electrical appliances. In one embodiment, the PLC transport protocol is a transport control protocol (TCP) applied in the PLC.

In block S304, the energy acquiring module 120 receives a plurality of energy response messages from the plurality of electrical appliances via the PLC transport protocol. In one embodiment, the plurality of energy response messages include the energy consumption of the plurality of electrical appliances.

In block S306, the display module 170 displays the energy consumption of the plurality of electrical appliances, such as “television: 2 kwh” and “computer: 1 kwh”. In one embodiment, the display module 170 may be a liquid crystal display.

In block S308, the control module 130 determines whether each energy consumption of each electrical appliance exceeds the corresponding energy consumption threshold.

If each energy consumption of each electrical appliance does not exceed the corresponding energy consumption threshold, going back to block S302, the energy acquiring module 120 goes on to transmit a plurality of energy request commands to the plurality of electrical appliances via the PLC transport protocol.

If the energy consumption of at least one electrical appliance exceeds the corresponding energy consumption threshold, the control module 130 generates an energy alarm to notify a user that the at least one electrical appliance will be powered off as shown in block S310. In one embodiment, the control module 130 may drive the loudspeaker 140 to generate the energy alarm.

In another embodiment, the control module 130 may drive the television 20 to generate the energy alarm when the television 20 is turned on.

In block S312, the control module 312 determines whether the energy alarm is canceled by the user.

If the energy alarm is not canceled, in block S314, the control module 130 transmits a power-off request command to the at least one electrical appliance via the PLC transport protocol to power off the at least one electrical appliance.

If the energy alarm is canceled, in block S316, the control module 130 notifies the user to reset the energy consumption threshold corresponding to the at least one electrical appliance.

In general, the set-top box 10 manages energy consumption of the plurality of electrical appliances via the TCP, which can avoid the energy consumption of each electrical appliance exceeds the corresponding energy consumption threshold. Thus, energy consumption and energy costs are reduced.

While various embodiments of the present disclosure have been described above, it should be understood that they have been presented using example only and not using limitation. Thus the breadth and scope of the present disclosure should not be limited by the above-described embodiments, but should be defined only in accordance with the following claims and their equivalents.

What is claimed is:

1. A set-top box for establishing a power line communication (PLC) with a plurality of electrical appliances, the set-top box comprising:
one or more processors;
a storage system; and
one or more programs, wherein the one or more programs are stored in the storage system and executed by the one or more processors, the one or more programs comprising:
an energy setting module operable to set a plurality of energy consumption thresholds corresponding to the plurality of electrical appliances, wherein each of the plurality of energy consumption thresholds is maximum energy consumption consumed by each of the plurality of electrical appliances in a predetermined time period;
an energy acquiring module operable to transmit a plurality of energy request commands to the plurality of electrical appliances via a PLC transport protocol to request for energy consumption of the plurality of electrical appliances, and receive a plurality of energy response messages from the plurality of electrical appliances via the PLC transport protocol, wherein the plurality of energy response messages comprise the energy consumption of the plurality of electrical appliances; and
a control module operable to determine whether each energy consumption of each electrical appliance exceeds the corresponding energy consumption threshold, and generate an energy alarm to notify a user that at least one of the plurality of the electrical appliances will be powered off when the energy consumption of the at least one electrical appliance exceeds the corresponding energy consumption threshold.

2. The set-top box as claimed in claim 1, wherein the storage system is further operable to store the energy consumption thresholds corresponding to the plurality of electrical appliances and a plurality of device identifiers corresponding to the plurality of the electrical appliances, wherein the plurality of device identifiers are used to identify the plurality of electrical appliances.

3. The set-top box as claimed in claim 2, wherein the PLC transport protocol is a transport control protocol (TCP) applied in the PLC, and the plurality of energy request commands and the plurality of energy response messages are PLC packets.

4. The set-top box as claimed in claim 3, wherein each of the plurality of energy request commands comprises a source port field, a destination port field, a device identifier field, and a request type field, wherein the source port field is set to a port of the set-top box, the destination port field is set to a port of one of the plurality of electrical appliances, the device identifier field is set to one device identifier corresponding to the one electrical appliance, and the request type field is set to energy query datagram predefined between the set-top box and the one electrical appliance.

5. The set-top box as claimed in claim 3, where each of the plurality of energy response messages comprises a source port field, a destination port field, a device identifier field, and an energy value field, wherein the source port field is set to a port of one of the plurality of electrical appliances, the destination port field is set to a port of the set-top box, the device identifier field is set to one device identifier corresponding to the one electrical appliance, and the energy value field is set to the energy consumption of the one electrical appliance.

6. The set-top box as claimed in claim 3, wherein the control module is further operable to determine whether the energy alarm is canceled by the user, transmit a power-off request command to the at least one electrical appliance via the PLC transport protocol to power off the at least one electrical appliance when the energy alarm is not canceled, and notify the user to reset the corresponding energy consumption threshold when the energy alarm is canceled.

7. The set-top box as claimed in claim 6, wherein each of the plurality of power-off request commands comprises a source port field, a destination port field, a device identifier field, and a request type field, wherein the source port field is set to a port of the set-top box, the destination port field is set to a port of one of the plurality of electrical appliances, the device identifier field is set to one device identifier corresponding to the one electrical appliance, and the request type field is set to power-off request datagram predefined between the set-top box and the one electrical appliance.

8. The set-top box as claimed in claim 1, wherein the control module is further operable to drive a selective one of a loudspeaker and a television connected to the set-top box to generate the energy alarm.

9. The set-top box as claimed in claim 1, further comprising a display module operable to display the energy consumption of the plurality of electrical appliances.

10. An energy management method applied in a set-top box establishing a power line communication with a plurality of electrical appliances, the energy management method comprising:
setting a plurality of energy consumption thresholds corresponding to the plurality of electrical appliances, wherein each of the plurality of energy consumption thresholds is maximum energy consumption consumed by each of the plurality of electrical appliances in a predetermined time period;
transmitting a plurality of energy request commands to the plurality of electrical appliances via a PLC transport protocol to request for energy consumption of the plurality of electrical appliances;
receiving a plurality of energy response messages from the plurality of electrical appliances via the PLC transport protocol, wherein the plurality of energy response messages comprises the energy consumption of the plurality of electrical appliances;
determining whether each energy consumption of each electrical appliance exceeds the corresponding energy consumption threshold;
generating an energy alarm to notify a user that at least one of the plurality of electrical appliances will be powered off when the energy consumption of the at least one electrical appliance exceeds the corresponding energy consumption threshold; and
executing the setting step, the transmitting step, the receiving step, the determining step, and the generating step using at least one processor.

11. The energy management method as claimed in claim 10, wherein each of the plurality of electrical appliances has a corresponding device identifier used to identify each electrical appliance.

12. The energy management method as claimed in claim 11, wherein the PLC transport protocol is a transport control protocol (TCP) applied in the PLC, and the plurality of energy request commands and the plurality of energy response messages are PLC packets.

13. The energy management method as claimed in claim 12, wherein each of the plurality of energy request commands comprises a source port field, a destination port field, a device identifier field, and a request type field, wherein the source port field is set to a port of the set-top box, the destination port field is set to a port of one of the plurality of electrical appliances, the device identifier field is set to one device identifier corresponding to the one electrical appliance, and the request type field is set to energy query datagram predefined between the set-top box and the one electrical appliance.

14. The energy management method as claimed in claim 12, where each of the plurality of energy response messages comprises a source port field, a destination port field, a device identifier field, and an energy value field, wherein the source port field is set to a port of one of the plurality of electrical appliances, the destination port field is set to a port of the set-top box, the device identifier field is set to one device identifier corresponding to the electrical appliance, and the energy value field is set to energy consumption of the electrical appliance.

15. The energy management method as claimed in claim 12, further comprising:
determining whether the energy alarm is canceled by the user;
transmitting a power-off request command to the electrical appliance via the PLC transport protocol to power off the at least one electrical appliance if the energy alarm is not canceled by the user; and
notifying the user to reset the energy consumption threshold corresponding to the at least one electrical appliance if the energy alarm is canceled by the user.

16. The energy management method as claimed in claim 15, wherein each of the plurality of power-off request commands comprises a source port field, a destination port field, a device identifier field, and a request type field, wherein the source port field is set to a port of the set-top box, the destination port field is set to a port of one of the plurality of electrical appliances, the device identifier field is set to one device identifier corresponding to the one electrical appliance, and the request type field is set to power-off request datagram predefined between the set-top box and the one electrical appliance.

17. The energy management method as claimed in claim 10, further comprising:
driving one of a loudspeaker and a television connected to the set-top box to generate the energy alarm.

18. The energy management method as claimed in claim 10, further comprising:
displaying the energy consumption of the plurality of electrical appliances.
